(19) United States
(12) Patent Application Publication
(10) Pub. No.: US 2025/0319755 A1
(43) Pub. Date: Oct. 16, 2025

(54) OPENING TRIM WEATHER STRIP

(71) Applicant: TOYODA GOSEI CO., LTD., Kiyosu-shi (JP)

(72) Inventors: Shinnosuke HAMADA, Kiyosu-shi (JP); Kentaro ADACHI, Kiyosu-shi (JP); Yuto UEHARA, Kiyosu-shi (JP)

(21) Appl. No.: 19/075,894

(22) Filed: Mar. 11, 2025

(30) Foreign Application Priority Data
Apr. 11, 2024 (JP) 2024-063743

(51) Int. Cl. B60J 10/24; B60J 10/16; B60J 10/27; B60J 10/80

(52) U.S. Cl. CPC B60J 10/24; B60J 10/16; B60J 10/27; B60J 10/80

(57) ABSTRACT

A hollow seal portion includes: a first root formed using a material with hardness lower than the attachment base and connected to an end of a vehicle outer side wall opposite to an open portion; a second root connected to the vehicle outer side wall closer to a bottom wall than the first root; and a hollow wall connected to the first and second roots. The first root is formed in a substantially triangular shape in which a wall thickness decreases in a direction of the hollow wall, and includes a connecting portion connected to the hollow wall at an apex portion of the substantially triangular shape. A coating layer with hardness higher than the hollow seal portion is formed on an outer surface between the vicinity of the connecting portion on the hollow wall side and the vicinity of the second root on the hollow wall side.

### CROSS REFERENCE TO RELATED APPLICATION

This application claims the priority benefit of Japanese Patent Application No. 2024-063743 filed on Apr. 11, 2024. The entirely of the above-mentioned patent application is hereby incorporated by reference herein and made a part of this application.

### BACKGROUND OF THE INVENTION

### (1) Field of the Invention

The present invention relates to an opening trim weather strip made of resin, which is disposed in an opening opened and closed by a door or the like of an automobile and is attached to a flange formed at the peripheral edge of the opening.

### (2) Description of Related Art

In recent years, the growing need for carbon neutrality has led to a demand for converting rubber members to resin members for weather strips, including opening trim weather strips, to reduce carbon dioxide emissions generated during the manufacture of rubber parts of automobiles.

For example, FIG. 5 shows an opening trim weather strip 100 including: an attachment base 200 attached to a rear side longitudinal edge of a flange 500 provided at a peripheral edge of a vehicle body opening; and a hollow seal portion 240 integrally provided on the attachment base 200 and contacts a door to seal between the door and the peripheral edge of the vehicle body opening (Japanese Patent Application Laid-Open No. 2010-149838).

The hollow seal portion 240 includes a first side seal wall 310, a second side seal wall 320, and a contact seal wall 330. The first side seal wall 310 and the second side seal wall 320 are integrally formed of a solid material, protruding in the vehicle outer direction from the attachment base 200. The contact seal wall 330 is formed of a sponge material, protruding in a cross-sectional arc shape so as to connect the tips of the first side seal wall 310 and the second side seal wall 320.

A hollow seal skin layer 340 made of a solid material is formed on the surface of the hollow seal portion 240 in a portion where the torso (back, waist) and head of an occupant easily come into contact with the hollow seal portion 240 when the occupant gets in and out of an automobile. The thickness of the hollow seal skin layer 340 is 0.3 mm to 0.5 mm. The hollow seal skin layer 340 is also formed in a portion other than the rear side longitudinal edge, and the thickness of the hollow seal skin layer 340 in that portion is smaller than the above numerical values. As a result, by covering the surface of the hollow seal portion 240 with a smooth solid layer, the appearance from the outside of the vehicle can be improved, and the wear resistance can be improved by the hollow seal skin layer 340.

Japanese Patent Application Laid-Open No. 2010-149838 also describes that the hollow seal portion 240 is formed of a sponge material of an ethylene propylene diene monomer (EPDM) rubber or an olefinic thermoplastic elastomer.

FIG. 6 describes the following: a back door opening trim 101 includes a main body portion 103 attached to a vehicle body panel 102 (flange), cantilevered seal portions 105, 107 that seal a gap in the vehicle body panel 102, and a hollow cylindrical seal portion 106. The seal portions 105, 106, 107 are elastically in contact with the vehicle body panel 102 while being attached to the vehicle body panel 102. The seal portions 105, 106, 107 are formed of a thermoplastic elastomer containing an olefin block copolymer (Japanese Patent Application Laid-Open No. 2018-132097).

### SUMMARY OF THE INVENTION

Japanese Patent Application Laid-Open No. 2010-149838 describes that the hollow seal portion can be made of a sponge material of an EPDM rubber or an olefinic thermoplastic elastomer. However, when the rubber is replaced with the thermoplastic elastomer, the thermoplastic elastomer is more susceptible to wear than the rubber, that is, the thermoplastic elastomer has less resilience when compression is dynamically or statically applied for a certain period of time. Simple material replacement will lead to deterioration of sealing performance and noise vibration (NV) performance due to wear in the hollow seal portion. In addition, Japanese Patent Application Laid-Open No. 2018-132097 describes the material aspect, but it is also necessary to consider the structure and shape aspects.

The present invention provides an opening trim weather strip made of resin. In the process of converting an opening trim weather strip to resin, its structure and shape have been particularly improved to enhance fatigue resistance. The opening trim weather strip can prevent deterioration of sealing performance and noise vibration (NV) performance and adjust the force to be applied when a door is closed.

To solve the above problems, a first aspect of the present invention is an opening trim weather strip that is made of resin and attached to a flange of a vehicle body, the opening trim weather strip including: an attachment base that has a substantially U-shaped cross section and includes a vehicle outer side wall, a vehicle inner side wall, a bottom wall, and an open portion, the bottom wall connecting the vehicle outer side wall and the vehicle inner side wall, the open portion being open at an end on a side opposite to the bottom wall; and a hollow seal portion that has an arc shape, is integrated with the vehicle outer side wall of the attachment base, and protrudes convexly in a direction away from the vehicle outer side wall. The hollow seal portion is formed using a material having hardness lower than the hardness of the attachment base. The hollow seal portion includes
a first root connected to an end of the vehicle outer side wall opposite to the open portion, a second root connected to the vehicle outer side wall closer to the bottom wall than the first root, and a hollow wall connected to the first root and the second root. The first root is formed in a shape in which a wall thickness decreases in a direction of the hollow wall, and includes a connecting portion connected to the hollow wall at an apex portion of the first root.

In the first aspect of the present invention, the hollow seal portion is formed using a material having hardness lower than the hardness of the attachment base, the hollow seal portion includes a first root connected to an end of the vehicle outer side wall opposite to the open portion, a second root connected to the vehicle outer side wall closer to the bottom wall than the first root, and a hollow wall connected to the first root and the second root, and the first root is formed in a shape in which a wall thickness decreases in a direction of the hollow wall, and includes a connecting portion connected to the hollow wall at an apex portion of the first root. Therefore, when the hollow seal portion comes into contact with the door and deforms, the hollow seal portion deforms with the connecting portion serving as a bending point. Therefore, the volume of the first root, that is, the thickness on the vehicle outer side wall side and the height in the direction of the hollow wall, enables adjustment of the force to be applied when the door is closed.

A second aspect of the present invention is the opening trim weather strip made of resin according to the first aspect, in which the hollow wall includes a top portion having a maximum degree of curvature on a side closer to the bottom wall than the connecting portion, and a thick-walled portion is formed between the connecting portion and the top portion.

In the second aspect of the present invention, in the hollow wall, the hollow wall includes the top portion having the maximum degree of curvature on the side closer to the bottom wall than the connecting portion, and the thick-walled portion is formed between the connecting portion and the top portion. Therefore, when the door is closed, the door and the thick-walled portion come into contact with each other, making it possible to prevent large deformation of the contact portion from in the hollow wall. The energy from the door received by the contact portion with the door can be propagated and dispersed to the first root side and the second root side. As a result, the fatigue resistance of the hollow seal portion can be improved to prevent deterioration of sealing performance and NV performance.

A third aspect of the present invention is the opening trim weather strip made of resin according to the second aspect, in which the top portion of the hollow wall is located closer to the bottom wall than the second root and closer to the open portion than the bottom wall.

In the third aspect of the present invention, the top portion of the hollow wall is located closer to the bottom wall than the second root and closer to the open portion than the bottom wall. Therefore, when the hollow seal portion comes into contact with the door and deforms, the hollow seal portion can be greatly deformed toward the bottom wall side. As a result, it is possible to bring the hollow seal portion into contact with the door while reducing the reaction force to the door, thereby improving the fatigue resistance of the hollow seal portion and preventing deterioration of sealing performance and NV performance.

A fourth aspect of the present invention is the opening trim weather strip made of resin according to the first aspect to the third aspect, in which a coating layer having hardness higher than the hardness of the hollow seal portion is formed on an outer surface between a vicinity of the connecting portion on the hollow wall side and a vicinity of the second root on the hollow wall side.

In the fourth aspect of the present invention, the coating layer having hardness higher than the hardness of the hollow seal portion is formed on an outer surface between the vicinity of the connecting portion on the hollow wall side and the vicinity of the second root on the hollow wall side. Therefore, the wear resistance of the hollow seal portion can be maintained and the fatigue resistance of the hollow seal portion can be improved, thereby preventing deterioration of sealing performance and NV performance.

Note that it is undesirable to form a coating layer having high hardness on the first root side of the connecting portion and the vehicle outer side wall side of the second root, that is, a portion where the hollow seal portion is greatly bent and deforms when coming into contact with the door, because the fatigue resistance of the bent portion deteriorates.

A fifth aspect of the present invention is the resin opening trim weather strip according to the fourth aspect, in which the hardness of the coating layer is higher than the hardness of the attachment base.

In the fifth aspect of the present invention, the hardness of the coating layer is higher than the hardness of the attachment base. Therefore, it is possible to maintain the wear resistance of the hollow seal portion and improve the fatigue resistance of the hollow seal portion while maintaining the assembly capability and retention of the attachment base to the flange. As a result, it is possible to produce an opening trim weather strip made of resin that can prevent deterioration of sealing performance and NV performance.

### BRIEF DESCRIPTION OF THE DRAWINGS

FIG. 1 is a perspective view from the rear in a state where a door of an automobile is opened.

FIG. 2 is a front view of an opening trim weather strip according to an embodiment of the present invention.

FIG. 3 is a cross-sectional view of the opening trim weather strip according to the embodiment of the present invention.

FIG. 4 is a cross-sectional view illustrating deformation of a hollow seal portion when the door is closed in FIG. 3.

FIG. 5 is a cross-sectional view of a conventional opening trim weather strip (Japanese Patent Application Laid-Open No. 2010-149838).

FIG. 6 is a cross-sectional view of a conventional back door opening trim weather strip (Japanese Patent Application Laid-Open No. 2018-132097).

### DETAILED DESCRIPTION OF PREFERRED EMBODIMENTS

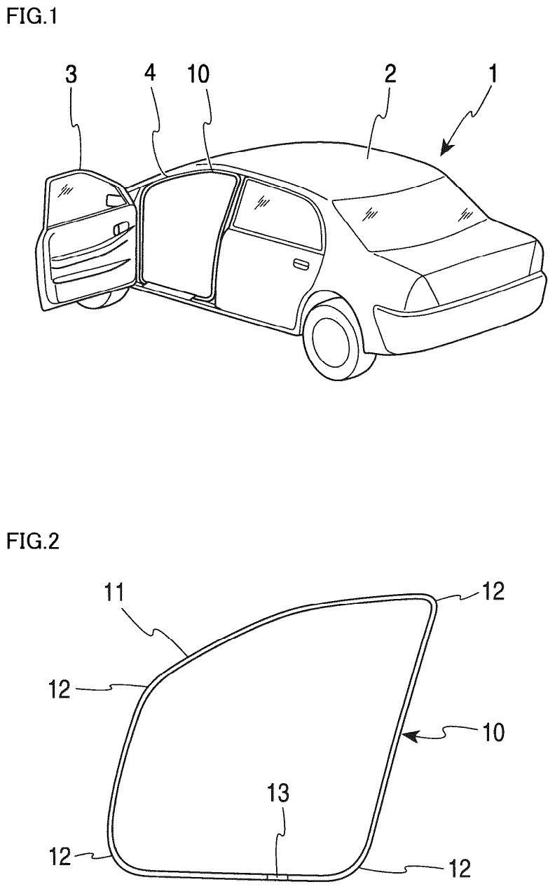

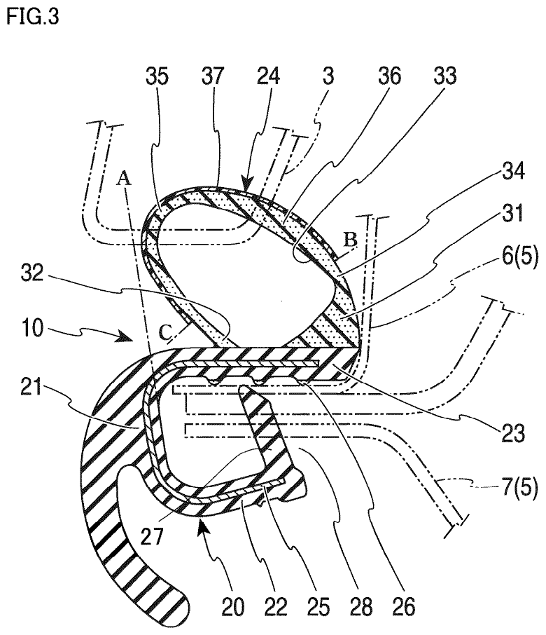

With reference to FIGS. 1 to 4, an opening trim weather strip according to an embodiment of the present invention will be described. FIG. 1 is a perspective view from the rear in a state where a door of an automobile is opened. A vehicle body 2 of an automobile 1 has a door opening, and the door opening is opened and closed by a door 3. The periphery of the door opening forms a vehicle body opening peripheral edge 4, and the vehicle body opening peripheral edge 4 includes an outer panel 6 and a flange 5 (FIG. 3), such as an inner panel 7, constituting the vehicle body 2. An opening trim weather strip 10 is attached to the flange 5.

FIG. 2 is a front view of an opening trim weather strip according to an embodiment of the present invention. The opening trim weather strip 10 is molded linearly by extrusion molding. After being cut to a predetermined length, the opening trim weather strip 10 is attached to the flange 5 while forming a linear portion 11 and a corner portion 12 so as to be annular along the shape of the vehicle body opening peripheral edge 4. After the attachment, both ends are connected by a connection 13.

FIG. 3 is a cross-sectional view of the opening trim weather strip according to the embodiment of the present invention. As shown in FIG. 3, the opening trim weather strip 10 includes: an attachment base 20 having a substantially U-shaped cross section and including a vehicle outer side wall 23, a vehicle inner side wall 22, a bottom wall 21, which connects the vehicle outer side wall 23 and the vehicle inner side wall 22, and an open portion 28 that is open at the end on the side opposite to the bottom wall 21; a hollow seal portion 24 integrated with the vehicle outer side wall 23 of the attachment base 20; and a lip 27 extending diagonally from the vehicle outer side of the vehicle inner side wall 22 toward the vehicle outer side wall 23 and toward the bottom wall 21. An insert member 25 is embedded inside the attachment base 20 to increase the strength to grip the flange 5. Ribs 26 are formed at three locations on the vehicle inner side wall 22 side of the vehicle outer side wall 23. When the attachment base 20 of the opening trim weather strip 10 is attached to the flange 5 including the outer panel 6 and the inner panel 7, the rib 26 elastically contacts the outer panel 6 and the lip 27 elastically contacts the inner panel 7.

The hollow seal portion 24 is integrated with the vehicle outer side wall 23 of the attachment base 20, and is formed in an arc shape protruding in a convex shape in a direction away from the vehicle outer side wall 23. Further, the hollow seal portion 24 includes a first root 31 connected to the end of the vehicle outer side wall 23 opposite to the open portion 28, a second root 32 connected to the vehicle outer side wall 23 on the bottom wall 21 side of the first root 31, and a hollow wall 33 connected to the first root 31 and the second root 32.

The first root 31 is formed in a substantially triangular shape with a decreasing wall thickness in the direction of the hollow wall 33, and includes a connecting portion 34 connected to the hollow wall 33 at the apex portion of the substantially triangular shape.

A top portion 35 of the curve of the hollow wall 33, where the degree of curvature is maximum, is located closer to the bottom wall 21 than the second root 32. The top portion 35 is located closer to the open portion 28 than the bottom wall 21 (dashed line A).

In the hollow wall 33, a thick-walled portion 36 is formed between the connecting portion 34 and the top portion 35. The thick-walled portion 36 gradually becomes thicker from both sides of the connecting portion 34 and the top portion 35 and, in FIG. 3, reaches its greatest thickness approximately in the middle between the connecting portion 34 and the top portion 35.

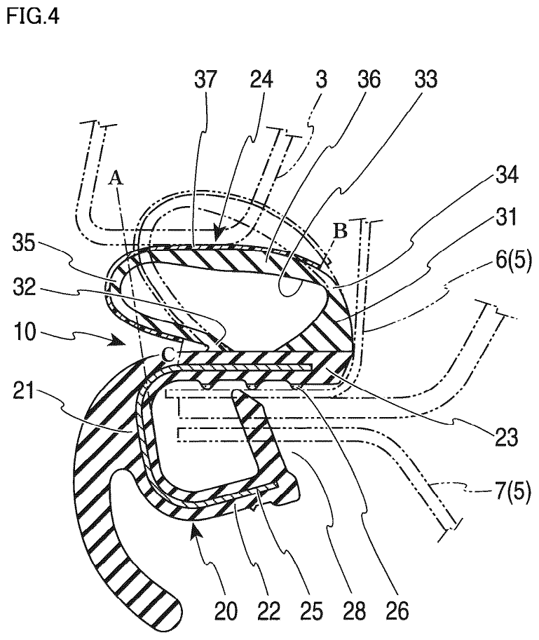

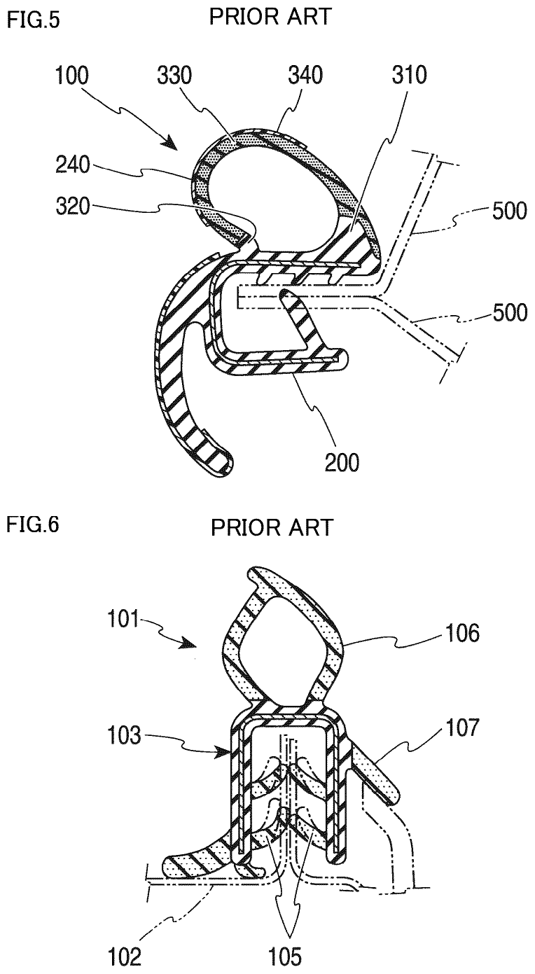

As shown in FIG. 4, the thick-walled portion 36 is formed so that a portion between the connecting portion 34 and the top portion 35 deforms into a shape close to a straight line. Therefore, the thick-walled portion 36 does not necessarily need to have its greatest thickness approximately in the middle between the connecting portion 34 and the top portion 35.

A coating layer 37 is formed on the outer surface between the vicinity (B) of the connecting portion 34 on the hollow wall 33 side and the vicinity (C) of the second root 32 on the hollow wall 33 side. As shown in FIG. 4, the coating layer 37 is formed on the hollow wall 33 side from a portion where the first root 31 and the second root 32 are bent greatly. In the present embodiment, the thickness of the coating layer 37 is 0.5 mm.

In the present embodiment, for the attachment base 20 and the lip 27 of the opening trim weather strip 10, a dynamically crosslinked thermoplastic elastomer (TPV) having an International Rubber HardnessDegree (IRHD) of 80±10 was used as a resin material. For the hollow seal portion 24 and the rib 26, a soft TPV having an IRHD of 40±10 was used. For the coating layer 37, a TPV having an IRHD of 90±10, which is higher in hardness than the attachment base 20, was used. Note that the hardness of the coating layer 37 may be the same as that of the attachment base 20.

FIG. 4 is a cross-sectional view when the door is closed in FIG. 3, illustrating in particular the deformation of the hollow seal portion 24. As shown in FIG. 4, the hollow seal portion 24 deforms with the connecting portion 34 serving as a bending point, and the top portion 35 of the curve of the hollow wall 33, where the degree of curvature is maximum, greatly moving toward the bottom wall 21.

A portion of the hollow wall 33 between the connecting portion 34 and the top portion 35 deforms into a shape close to a straight line. About one-half of the area of the thick-walled portion 36 is in contact with the door 3. By bringing the hollow wall into contact with the door 3 in this state, it is possible to prevent large deformation of the hollow wall 33 other than the thick-walled portion 36 at the boundary with the thick-walled portion 36 and to deform the portion between the connecting portion 34 and the top portion 35 into a shape close to a straight line.

As described above in detail, according to the present embodiment, the following effects can be obtained.
(1) In the above embodiment, the hollow seal portion 24 is formed using a material having hardness lower than the hardness of the attachment base 20, the hollow seal portion 24 includes the first root 31 connected to an end of the vehicle outer side wall 23 opposite to the open portion 28, the second root 32 connected to the vehicle outer side wall 23 closer to the bottom wall 21 than the first root 31, and the hollow wall 33 connected to the first root 31 and the second root 32, and the first root 31 is formed in a substantially triangular shape in which the wall thickness decreases in the direction of the hollow wall 33, and includes the connecting portion 34 connected to the hollow wall 33 at an apex portion of the substantially triangular shape. Therefore, when the hollow seal portion 24 comes into contact with the door 3 and deforms, the hollow seal portion 24 deforms with the connecting portion 34 serving as a bending point. Therefore, the force to be applied when the door 3 is closed can be adjusted by the volume of the substantially triangular first root 31, that is, the width on the vehicle outer side wall 23 side and the height from the vehicle outer side wall 23 to the connecting portion 34.
(2) Further, in the above embodiment, the top portion 35 of the curve, where the degree of curvature is maximum, is located closer to the bottom wall 21 than the second root 32 and closer to the open portion 28 than the bottom wall 21 (dashed line A). Therefore, the hollow seal portion 24 can be greatly deformed toward the bottom wall 21 when the hollow seal portion 24 comes into contact with the door 3 and deforms. As a result, it is possible to bring the hollow seal portion 24 into contact with the door 3 while reducing the reaction force to the door 3, thereby improving the fatigue resistance of the hollow seal portion 24 and preventing deterioration of sealing performance and NV performance.
(3) Further, in the above embodiment, in the hollow wall 33, the thick-walled portion 36 is formed between the connecting portion 34 and the top portion 35, and about one-half of the area of the thick-walled portion 36 is in contact with the door 3. Therefore, the portion between the connecting portion 34 and the top portion 35 deforms into a shape close to a straight line, making it possible to prevent the deformation from concentrating on the contact portion with the door 3, and to disperse the energy from the door 3 at the contact portion with the door 3 to the first root 31 side and the second root 32 side in the hollow seal portion 24. As a result, the fatigue resistance of the hollow seal portion 24 can be improved to prevent deterioration of sealing performance and NV performance.
(4) The coating layer 37 having hardness higher than the hardness of the hollow seal portion 24 is formed on the outer surface between the vicinity of the connecting portion 34 on the hollow wall 33 side and the vicinity of the second root 32 on the hollow wall 33 side. Therefore, the wear resistance of the hollow seal portion 24 (hollow wall 33) can be maintained and the fatigue resistance of the hollow seal portion 24 can be improved, thereby preventing deterioration of sealing performance and NV performance. In addition, the hardness of the coating layer 37 is higher than the hardness of the attachment base 20. Therefore, it is possible to maintain the wear resistance of the hollow seal portion 24 and improve the fatigue resistance of the hollow seal portion 24 while maintaining the assembly capability and retention of the attachment base 20 to the flange 5, thereby preventing deterioration of sealing performance and NV performance.

Implementing the embodiment is not limited to the above embodiment, and various modifications can be made without departing from the object of the present invention.

In the above embodiment, a dynamically crosslinked thermoplastic elastomer (TPV) has been used as the resin material constituting the opening trim weather strip 10. However, a thermoplastic elastomer (TPE), such as a styrene thermoplastic elastomer (TPS) or an olefinic thermoplastic elastomer (TPO), other than TPV, may also be used. Note that a TPV is desirable from the viewpoint of good fatigue resistance (compression set) and coping with a wide range of hardness.

A thermoplastic elastomer has both resin and rubber properties and is suitable for manufacturing a weather strip, including an opening trim weather strip, from the viewpoint of weather resistance, recyclability, cost, and the like. Other resins such as polyethylene (PE) and polypropylene (PP) can also be partially used.

What is claimed is:

1. An opening trim weather strip made of resin and attached to a flange of a vehicle body, the opening trim weather strip comprising:
an attachment base that has a substantially U-shaped cross section and includes a vehicle outer side wall, a vehicle inner side wall, a bottom wall, and an open portion, the bottom wall connecting the vehicle outer side wall and the vehicle inner side wall, the open portion being open at an end on a side opposite to the bottom wall; and
a hollow seal portion that has an arc shape, is integrated with the vehicle outer side wall of the attachment base, and protrudes convexly in a direction away from the vehicle outer side wall,
wherein
the hollow seal portion is formed using a material having hardness lower than hardness of the attachment base,
the hollow seal portion includes
a first root connected to an end of the vehicle outer side wall opposite to the open portion,
a second root connected to the vehicle outer side wall closer to the bottom wall than the first root, and
a hollow wall connected to the first root and the second root, and
the first root is formed in a shape in which a wall thickness decreases in a direction of the hollow wall, and includes a connecting portion connected to the hollow wall at an apex portion of the first root.

2. The opening trim weather strip made of resin according to claim 1, wherein the hollow wall includes a top portion having a maximum degree of curvature on a side closer to the bottom wall than the connecting portion, and a thick-walled portion capable of coming into contact with a door is formed between the connecting portion and the top portion.

3. The opening trim weather strip made of resin according to claim 2, wherein the top portion of the hollow wall is located closer to the bottom wall than the second root and closer to the open portion than the bottom wall.

4. The opening trim weather strip made of resin according to claim 1, wherein a coating layer having hardness higher than hardness of the hollow seal portion is formed on an outer surface between a vicinity of the connecting portion on the hollow wall side and a vicinity of the second root on the hollow wall side.

5. The opening trim weather strip made of resin according to claim 4, wherein the hardness of the coating layer is higher than the hardness of the attachment base.
